(19) United States
(12) Patent Application Publication
(10) Pub. No.: US 2026/0351907 A1
(43) Pub. Date: Nov. 5, 2026

(54) DEVICE FOR PRODUCING AN ELECTRICAL CONNECTION BETWEEN A HIGH-VOLTAGE LINE AND A HIGH-VOLTAGE COMPONENT

(71) Applicant: MERCEDES-BENZ GROUP AG, Stuttgart (DE)

(72) Inventors: Johannes JANOTTA, Neckarbischofsheim (DE); Oliver MZYK, Oberreichenbach (DE)

(21) Appl. No.: 19/134,386

(22) PCT Filed: Nov. 30, 2023
(86) PCT No.: PCT/EP2023/083841

§ 371 Date: May 30, 2025

(30) Foreign Application Priority Data
Dec. 2, 2022 (DE) 10 2022 004 518.4

(51) Int. Cl. H01R 24/28; H01R 13/207; H01R 13/53; H01R 13/6582

(52) U.S. Cl. CPC H01R 24/28; H01R 13/207; H01R 13/53; H01R 13/6582

(57) ABSTRACT

A device produces an electrical connection between a high-voltage line and a high-voltage component having a housing. The device includes a plug connector having at least one pin connector housing and at least one contact pin. The plug connector, the at least one pin connector housing, and the at least one contact pin are arranged on the housing in a non-destructive, externally replaceable manner.

### BACKGROUND AND SUMMARY OF THE INVENTION

Exemplary embodiments of the invention relate to a device for producing an electrical connection between a high-voltage line and a high-voltage component

For connecting different components of a high-voltage system, lines are typically used that are connected to pin connectors of the components using plug connectors.

For this purpose, DE 10 2019 132 599 A1 discloses a holder arrangement of a line element designed for transmitting electrical energy to a housing of a motor vehicle. The line element has an electrical conductor for transmitting the electrical energy and a sleeve ensheathing at least one longitudinal region of the conductor and electrically insulating the guide. A connecting element, designed separately from the line element, is secured to the line element and has a flange arranged on a first side of a wall of the housing, by means of which the connecting element and via this the line element are fixed on the housing. At least the conductor extends through a first through-opening of the flange and through a second through-opening of the housing.

In addition, DE 10 2018 202 955 A1 discloses a plug-in connector system having a plug connector and a housing on which the plug connector is mounted. The housing has an opening with a first inner wall. The plug connector has a shielding plate at least partially protruding into the opening. A ring is arranged in the opening and electrically contacts the first inner wall of the opening with an outer wall. In the process, the shielding plate electrically contacts a second inner wall of the ring with a further outer wall of the shielding plate.

DE 10 2020 123 476 A1 discloses a socket having a first connector face for connecting a plug and having a second connector face with at least one contact assembly that can be fixed or releasably fixed thereon and that has at least one contact element and/or via which the electrical energy and/or the electrical signals can be transmitted by means of at least one electrical line.

Exemplary embodiments of the invention are directed to a device for producing an electrical connection between a high-voltage line and a high-voltage component, which can be replaced in a simple manner.

Favorable embodiments and advantages of the invention result from the description and the drawings.

According to one aspect of the invention, a device for producing an electrical connection between a high-voltage line and a high-voltage component having a housing, at least comprising a plug connector having at least one pin connector housing and at least one contact pin. In this case, the plug connector, the at least one pin connector housing, and the at least one contact pin are arranged on the housing in a non-destructive, externally replaceable manner.

Advantageously, the proposed device for producing an electrical connection between a high-voltage line and a high-voltage component is accessible from outside the high-voltage component and can be attached from the outside to the high-voltage component and thus be replaced. The mechanical and electrical connection of the at least one contact pin to the busbars of the high-voltage component is similarly possible from outside the high-voltage component.

The plug connector is therefore arranged releasably, in particular in a replaceable manner, on an outer side of the housing of the high-voltage component. The plug connector has a pin connector housing for receiving a mating plug connector of the high-voltage line. The pin connector housing is arranged on an opening of the housing in an externally releasable, in particular replaceable manner. The plug connector furthermore has at least one contact pin for producing an electrical connection to the mating plug connector and for mechanical and electrical connection to busbars of the high-voltage component in the interior of the housing, which are arranged on the housing in an externally releasable, in particular replaceable manner.

In the event of a necessary repair to the device, the pin connector housing can be repaired without disassembling the high-voltage component or, depending on the fault and embodiment type, without the need to check the sealability again.

There does not have to be access to the pin connector in the interior of the high-voltage component, as the at least one contact pin is screwed onto the busbars from the outside and in this respect, screws are not necessary for contacting the at least one contact pin inside.

The scope for design increases for possible positions of the pin connector, whereby more favorable arrangements of the connections and a more efficient use of the installation space in high-voltage batteries are possible for range-relevant cells.

The device for producing a plug-in connection between a high-voltage line and the high-voltage component can be arranged on the housing of the high-voltage component by initially guiding the pin connector housing to the opening of the housing. Subsequently, the at least one contact pin of the pin connector housing is screwed to busbars in the interior of the housing. Subsequently, the pin connector housing is screwed to the housing of the high-voltage component.

In a favorable embodiment, the pin connector housing can remain installed while repairing the high-voltage component. The at least one contact pin can be exchanged individually in the event of a defect at a contact of the pin connector. Since no sealing components are replaced in the process, a final sealing test of the high-voltage component is not required after the exchange. Radial and surface contacts can be used on the at least one contact pin.

In a further favorable embodiment, both round as well as angular contact pins can be used. Furthermore, greater tolerances are possible when manufacturing the individual parts of the device.

Advantageously, the pin connector housing can be designed for a screw connection to the housing of the high-voltage component. Therefore, flexible mounting of and the option to exchange the pin connector housing is possible in the event of repair.

Favorably, the pin connector housing can have a sealing element for sealing to the housing of the high-voltage component, which encloses the opening when mounted as intended on the housing. In this manner, the pin connector housing can be securely sealed to the housing of the high-voltage component.

According to an advantageous embodiment of the device, the at least one contact pin can have been or can be screwed to the busbars of the high-voltage component. In this manner, the at least one contact pin can be connected to the busbars from outside the housing of the high-voltage component and can also be favorably exchanged in the event of repair.

According to an advantageous embodiment of the device, the pin connector housing can have aligning elements, which protrude into the interior of the housing when mounted as intended and are designed to connect to corresponding mating elements of the busbars. Therefore, the busbars can be positioned favorably for mounting by aligning them with the aid of the pin connector housing. The at least one contact pin can be favorably connected to the busbars after introducing the aligning elements of the pin connector housing into the corresponding mating elements of the busbars.

According to an advantageous embodiment of the device, the at least one contact pin can have a thread, in particular an external thread, for connecting to the busbars on an end facing away from a plug contact surface. In this manner, the at least one contact pin can be favorably positioned from outside the housing at connecting points of the busbars, for example drilled screw holes, and can be screwed to the busbars. This provides permanent contact of the at least one contact pin with the busbars.

According to an advantageous embodiment of the device, the at least one contact pin can have a threading aid on the thread for alignment in an internal thread of the busbars on the thread. In this manner, the at least one contact pin can be positioned even more easily from outside the housing at connecting points of the busbars, for example drilled screw holes, and can be screwed to the busbars. This provides permanent contact of the at least one contact pin with the busbars.

According to an advantageous embodiment of the device, the at least one contact pin can be enclosed by an insulation element as contact protection, which has a geometric shape of a standard drive on its outer side. In particular, the at least one contact pin can be embedded into the insulation element. The standard drive can have the geometry of an outer hexagon or a multi-tooth, for example. The at least one contact pin can be screwed by this standard drive directly into the thread of the busbars from the outside via openings provided in the pin connector housing for this purpose.

According to an advantageous embodiment of the device, the insulation element can have a surrounding electrical shield, in particular a metallic spring contact. In this case, the shield can be designed for electrical contact with the housing of the high-voltage component, in particular via spring contacts, when mounted as intended on the housing. In this manner, advantageously, the electrical shielding can be transferred from the plug-in connection to the component housing.

According to an advantageous embodiment of the device, the at least one contact pin can be arranged in a contact carrier, which is arranged in the pin connector housing so as to be movable at least in a plug-in direction. In this manner, the at least one contact pin can be positioned relative to the busbars and screwed to these. In an application with at least two contact pins, the contact pins can also be advantageously positioned relative to each other in this manner. Therefore, greater tolerances can also be permitted when manufacturing the pin connector housing. Advantageously, the contact carrier, in which the at least one contact pin is arranged, can be aligned in a plug-in direction when the at least one contact pin is screwed to the busbars. Favorably, the at least one contact pin can be designed as a radial contact or as a clamping contact.

According to an advantageous embodiment of the device, the at least one contact pin can have a through bore in its longitudinal extension, which is provided for receiving a screw for screwing the at least one contact pin to the busbars when mounted as intended. In particular, in this case, a screw head of the screw can have an insulating material as contact protection. The at least one contact pin can be reliably screwed to the busbars in this manner.

According to an advantageous embodiment of the apparatus, the screwing of the at least one contact pin to the busbars can take place via an internal thread formed in the busbars or via a threaded bush arranged on the busbars. In order to enable greater manufacturing tolerances, the threaded bush can be designed as a moveably mounted cage nut, for example. The at least one contact pin can thus be screwed securely from outside the housing of the high-voltage component to the busbars and allows reliable contact from the outside.

Advantageously, a connection of a high-voltage interlock line of the high-voltage component can be designed as a plug-in connection in the pin connector housing, when required. The connection can expediently take place from the rear of the pin connector. After guiding the device to the opening of the housing, the high-voltage interlock line can be plugged into the pin connector housing. The internal line set in the component can favorably have a small excess length for this purpose, so that this can be plugged in before mounting the pin connector and the excess line set can be pushed back into the component housing when mounting the pin connector.

Further advantages result from the following drawing description. An exemplary embodiment of the invention is illustrated in the drawings. The drawings, the description and the claims include numerous features in combination. The person skilled in the art will also expediently consider the features individually and combine them into useful further combinations.

### BRIEF DESCRIPTION OF THE DRAWING FIGURES

In the figures:

FIG. 1 shows a schematic section through a high-voltage component having a device for producing an electrical connection between a high-voltage line and the high-voltage component according to one exemplary embodiment of the invention;

FIG. 2 shows a section through a contact pin of the device according to FIG. 1 having an insulation element; and

FIG. 3 shows a schematic section through a high-voltage component having a device for producing an electrical connection between a high-voltage line and the high-voltage component according to a further exemplary embodiment of the invention.

In the figures, identical or similar components are provided with the same reference numerals. The figures only show examples and are not intended to be restrictive.

### DETAILED DESCRIPTION

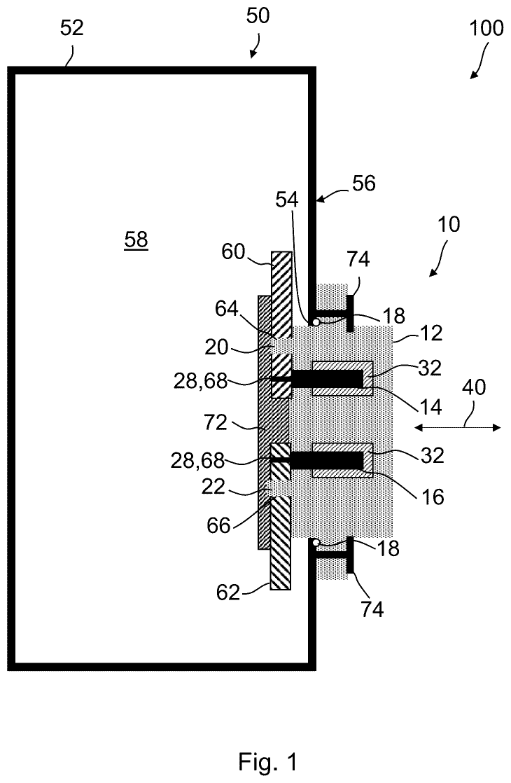

FIG. 1 shows a schematic section through a high-voltage component 50 having a device 100 for producing an electrical connection between a high-voltage line and the high-voltage component 50 according to one exemplary embodiment of the invention.

The device 100 comprises a plug connector 10, which has at least one pin connector housing 12 and two contact pins 14, 16. The plug connector 10, the at least one pin connector housing 12 and the two contact pins 14, 16 are arranged on the housing 52 of the high-voltage component 50 in a non-destructive, externally replaceable manner.

The plug connector 10 is arranged in a releasable, in particular replaceable manner on an outer side 56 of the housing 52 of the high-voltage component 50. The plug connector 10 has a pin connector housing 12 for receiving a mating plug connector of the high-voltage line. The pin connector housing 12 is arranged on an opening 54 of the housing 52 so as to be releasable from the outside. The plug connector 10 further has two contact pins 14, 16 for producing an electrical connection to the mating plug connector and for mechanical and electrical connection to busbars 60, 62 of the high-voltage component 50 in the interior 58 of the housing 52, which contact pins are arranged on the housing 52 so as to be releasable, in particular replaceable, from the outside. For this purpose, the two contact pins 14, 16 can be screwed to the busbars 60, 62 of the high-voltage component 50, for example.

A plug-in direction 40 in which the mating plug is plugged into the plug connector 10 is indicated with an arrow. The busbars 60, 62, which are connected in the interior 58 of the housing 52 to the contact pins 14, 16 of the high-voltage component 50, can be advantageously designed as one-piece or at least cohesively. For this purpose, the busbars 60, 62 can be over-molded together with plastic, for example, or can be aligned relative to each other in a common holder 72. Instead of holes for feeding through screws, threads can be provided in the busbars 60, 62. The thread can be designed directly in the busbars 60, 62 as a thread insert, passage, rivet nut, weld nut or, with sufficient material strength, as a sliced or formed thread.

The busbars 60, 62 can be pre-aligned via their screw connection to the housing 52.

Advantageously, a connection of a high-voltage interlock line of the high-voltage component 50 can be designed as a plug-in connection in the pin connector housing 12, when required. The connection can expediently take place from the rear of the plug connector 10. After guiding the device to the opening 54 of the housing 52, the high-voltage interlock line can be plugged into the pin connector housing 12. The internal line set in the component 50 can favorably have a small excess length for this purpose, so that this can be plugged in before mounting the plug connector 10 and the excess line set can be pushed back into the component housing 52 when mounting the plug connector 10.

The pin connector housing 12 can be screwed to the housing 52 of the high-voltage component 50, for example, via several screws. Furthermore, the pin connector housing 12 has a sealing element 18 for sealing to the housing 52, which encloses the opening 54 when mounted as intended on the housing 52. The plug connector on the line set subsequently seals to the pin connector housing 12 and seals the high-voltage component 50.

The pin connector housing 12 has aligning elements 20, 22, for example, injection molded pins, which protrude into the interior 58 of the housing 52 when mounted as intended and can be connected to corresponding mating elements 64, 66 of the busbars 60, 62. The busbars 60, 62 can be aligned by introducing the aligning elements 20, 22 of the pin connector housing 12 into these mating elements 64, 66 of the busbars 60, 62.

The distance of the contact pins 14, 16 to each other can be set via the distance of the thread in the busbars 60, 62. In order to keep the tolerances as low as possible, the creation of the thread or threaded tapping hole can be made by precise mechanical machining, for example by CNC milling, which can favorably take place, for example, by joint injection molding, after precisely aligning the two busbars to each other.

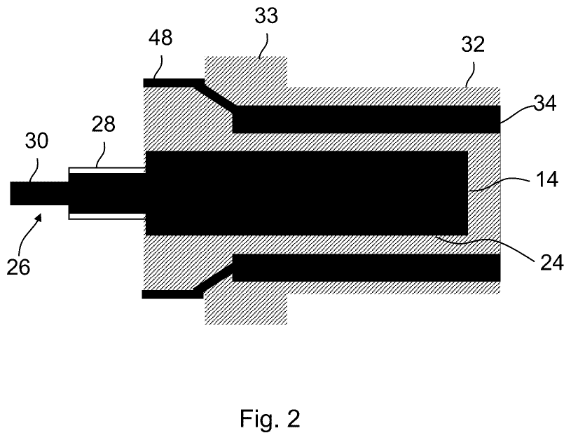

In FIG. 2, a section through a contact pin 14 of the device 100 is represented with an insulation element 32.

The contact pins 14, 16 have a thread 28 at an end 26 facing away from a plug contact surface 24, in particular an external thread for connecting to the busbars 60, 62. In particular, the contact pins 14, 16, as can be seen in FIG. 2, can have a threading aid 30 on the thread 28 for alignment in an internal thread 68 of the busbars 60,62.

The contact pins 14, 16 are each enclosed by an insulation element 32 as contact protection, which has a geometric shape 33 of a standard drive on its outer side. Advantageously, the contact pins 14, 16 can be embedded into the insulation element 32. The standard drive can have the geometry of an outer hexagon or a multi-tooth, for example. The contact pin 14, 16 can be screwed directly by this standard drive into the thread 68 of the busbars 60, 62 from the outside via openings provided in the pin connector housing for this purpose.

The insulation element 32 has a surrounding electrical shield 34, which, in particular, is designed as a metallic spring contact 48. The shield 34 is therefore designed for electrical contact with the housing 52 of the high-voltage component 50, in particular via spring contacts 48, when mounted as intended on the housing 52. When screwing in the contact pins 14, 16, the surrounding spring contact 48 can be connected via spring contacts 48 on the pin connector housing 12 to the metallic component housing 52. The line shield can be contacted at this spring contact 48 when using shielded high-voltage lines. In this manner, the electrical shielding can be transferred from the plug to the component housing 52.

The device 100 can be arranged on the housing 52 of the high-voltage component 50, by guiding the pin connector housing 10 to the opening 54 of the housing 52. Subsequently, the pin connector housing 12 can be screwed to the housing 52. Subsequently, the two contact pins 14, 16 of the pin connector housing 12 are screwed to the busbars 60, 62 in the interior 58 of the housing 52.

In the event of a defect on a contact of the plug connector 10, the contact pins 14, 16 can be individually exchanged. Since no sealing components are replaced in the process, a final sealing test of the component 50 is not required after the exchange. The contact pins 14, 16 can be designed as radial or surface contacts.

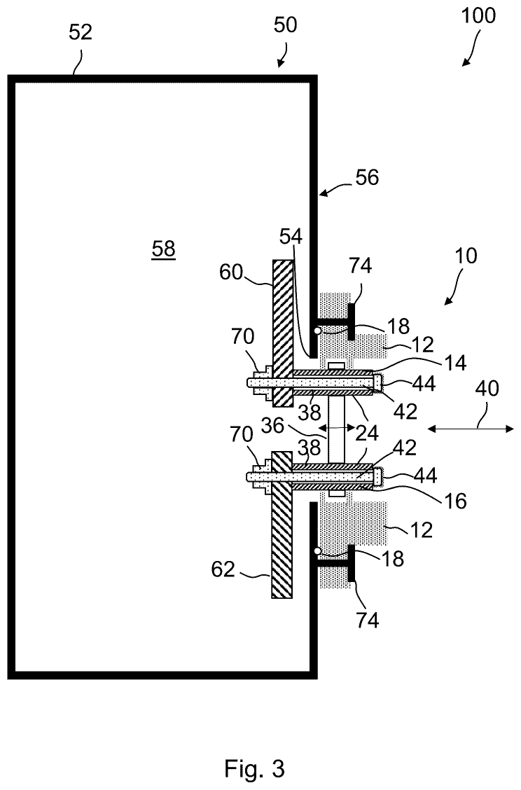

FIG. 3 shows a schematic section through a high-voltage component 50 with a device 100 for producing an electrical connection between a high-voltage line and the high-voltage component 50 according to a further exemplary embodiment of the invention.

In this exemplary embodiment, the plug connector 10 is designed as an assembly of at least two parts, specifically a pin connector housing 12 and at least one contact carrier 36 mounted therein, moveable in the plug-in direction 40, which are mounted together in one step on the high-voltage component 50. A sealing element 18, which seals to the component housing 52, is located on the pin connector housing 12. The plug connector on the line set subsequently seals to the pin connector housing 12 and seals the high-voltage component 50.

The two contact pins 14, 16 are arranged in the contact carrier 36, which can move in the pin connector housing 12 at least in a plug-in direction 40. The contact pins 14, 16 are very precisely aligned relative to each other in the contact carrier 36, for example injection molded together with plastic.

The two contact pins 14, 16 can be designed as radial contacts or as clamping contacts, for example.

The contact pins 14, 16 have a through bore 38 in their longitudinal extension. In each case, the contact pins 14, 16 can be fixed via at least one screw 42 to the busbars 60, 62 in the interior 58 of the component 50 via the through bores 38, and electrically connected as a result. The contact carrier 36 is mounted in the pin connector housing 12 so as to moveable in the plug-in direction 40, in order to be able to balance positioning tolerances between the pin connector housing 12 and the busbars 60, 62 in the plug-in direction 40, while screwing the contact pins 14, 16 to the busbars 60, 62 located therebehind. It is possible to balance tolerances in the radial direction, for example in relation to the position of the thread on the busbar surface, by correspondingly dimensioning the through bores 38 in relation to the screw 42. The contact carrier 36, in which the two contact pins 14, 16 are arranged, is aligned in the plug-in direction 40 when screwing the contact pins 14, 16 to the busbars 60, 62. When tightening the screw 42, the contact pin 14, 16 is fixed in the plug-in direction 40.

The screw head 44 is designed to be insulated. The insulation serves as contact protection.

The contact pins 14, 16 can be screwed to the busbars 60, 62 via an internal thread 68 formed in the busbars 60, 62 or, as can be seen in FIG. 3, via a threaded bush 70 arranged on the busbars 60, 62.

In this embodiment, round and angular contact pins 14, 16 can be implemented. Furthermore, simplified tolerance management is sufficient to fulfil the requirements for the plug-in connection.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

10 plug connector
12 pin connector housing
14 contact pin
16 contact pin
18 sealing element
20 aligning element
22 aligning element
24 plug contact surface
26 end
28 thread
30 threading aid
32 insulation element
33 geometric shape
34 shield
36 contact carrier
38 through bore
40 plug-in direction
42 screw
44 screw head
48 spring contact (of shield 34)
50 high-voltage component
52 housing
54 opening
56 outer side
58 interior (of the housing 52)
60 busbar
62 busbar
64 mating element
66 mating element
68 internal thread
70 threaded bush
72 holder
74 screw
100 device

1-10. (canceled)

11. A device configured to produce an electrical connection between a high-voltage line and a high-voltage component having a housing, the device comprising:
a plug connector having at least one pin connector housing and at least one contact pin,
wherein the plug connector, the at least one pin connector housing, and the at least one contact pin are arranged on the housing of the high-voltage component in a non-destructive, externally replaceable manner, and
wherein the at least one contact pin has a through bore a longitudinal extension of the at least one contact pin, wherein the through bore is configured to receive a screw to screw the at least one contact pin to busbars of the high-voltage component when the device is arranged on the high-voltage component.

12. The device of claim 11, wherein the at least one pin connector housing has aligning elements protruding into an interior of the housing when the device is arranged on the high-voltage component, and wherein the alignment elements are configured to connect to corresponding mating elements of the busbars of the high-voltage component.

13. The device of claim 11, wherein the at least one contact pin has a thread on an end facing away from a plug contact surface, wherein the thread is configured to connect to the busbars of the high-voltage component.

14. The device of claim 13, wherein the at least one contact pin has a threading aid on the thread configured to align in an internal thread of the busbars.

15. The device of claim 11, wherein the at least one contact pin is enclosed by an insulation element as contact protection, wherein the insulation element has a geometric shape of a standard drive on an outer side of the insulation element.

16. The device of claim 15, wherein the insulation element has a surrounding electrical shield, wherein the electrical shield is configured to electrically contact with the housing of the high-voltage component when the device is arranged on the high-voltage component.

17. The device of claim 11, wherein the at least one contact pin is arranged in a contact carrier, wherein the contact carrier is arranged in the pin connector housing so as to be moveable at least in a plug-in direction.

18. The device of claim 17, wherein a screw head of the screw has an insulating material as contact protection.

19. The device of claim 11, wherein screwing of the at least one contact pin to the busbars of the high-voltage component takes place via an internal thread formed in the busbars or via a threaded bush arranged on the busbars.
